(19) United States
(12) Patent Application Publication
(10) Pub. No.: US 2007/0043605 A1
(43) Pub. Date: Feb. 22, 2007

(54) System and method for time management and attributions

(75) Inventors: Reed Fisher, Oceanside, CA (US); Vinayak Sathe, Glen Allen, VA (US)

Correspondence Address: Michael J. Schallop, 18857 Harleigh Drive, Saratoga, CA, 95070, US

(73) Assignee: Aztec Pacific Incorporated

(21) Appl. No.: 11/429,823

(22) Filed: May 8, 2006

Related U.S. Application Data
(60) Provisional application No. 60/679,152, filed on May 9, 2005.

(51) Int. Cl. G06F 15/02

(52) U.S. Cl. 705/9

(57) ABSTRACT

The present invention provides improved systems and methods for time management and attributions. In one embodiment, a method for tracking a user's activity by time, includes: monitoring the user's activity on a computer; and tracking a plurality of user activities by time. In one embodiment, the method also includes determining whether the user has opened an existing file, created a new file, or closed a file. In one embodiment, the method further includes determining whether the user is actively working on a particular file that is associated with a particular client or matter, so that the time can be accurately attributed to the associated client or matter. In one embodiment, the method further includes tracking the user's activity to determine whether the user is actively working on an application or an active session, wherein the time tracking is associated with the currently active application or session that the user is presently working on during a logged period of time.

### REFERENCE TO RELATED APPLICATIONS

This patent application claims priority to pending provisional application Ser. No. 60/679,152, filed May 9, 2005 and entitled “System and Method for Time Management and Attributions”, which has the same named inventors Reed Fisher and Vinayak Sathe, and the same assignee as here in.

### BACKGROUND OF THE INVENTION

1. Field of the Invention

This invention pertains in general to computer based software and systems, and pertains, in particular, to systems and methods for time management and attributions.

2. Background Art

Many occupations and applications require time tracking. For example, attorneys, consultants, and other professionals need to track their time with particularity when they charge their clients for their time per project or matter. The need to accurately track time per project or matter is important to such professionals and others that charge their clients for their time. This need to accurately track time and also to do so efficiently when working on a variety of projects for different clients on any given day gives rise to the need for improved time management and attributions.

There are various solutions for tracking time for users. For example, many attorneys still use paper-based time sheets for tracking their time. Other professionals may use the equivalent in the form of electronic spreadsheets or text documents for manually entering the same information. More sophisticated software solutions exist for e-billing solutions, but these software solutions still do not automate the tracking of time for users, for example, on a user's computing and communication devices.

Software solutions also exist for monitoring computer activity, such as whether or not a user is actively using licensed software on their workstation. For example, see U.S. Pat. No. 6,622,116 providing a system for automatically collecting and for analyzing information about time and work performed on a computer using a hardware abstraction layer for monitoring activity on various user input devices. But this system merely monitors whether or not the user is actively working on the computer and allows the user to later allocate such logged activities by project or client matter. This system does not enable automatically tracking whether the user is actively working on a particular project or client matter by monitoring user activity in a particular application, file, or session and automatically allocating such logged time or activities to the appropriate project or client matter.

Thus, even these more sophisticated solutions typically have the common feature of requiring that the users manually track their time and/or take some action to track such time per client.

Accordingly, there exists a need for time tracking and attributions techniques that are not enabled or suggested by the current state of the art. Preferably, a solution meeting this need will improve the transparency of tracking and attributions without requiring continual or redundant, manual user interaction.

### DISCLOSURE OF INVENTION

The above need is met by the disclosed embodiments of systems and methods for time management and attributions. In one embodiment, a method for tracking a user's activity by time, includes: monitoring the user's activity on a computer; and tracking a plurality of user activities by time. In one embodiment, the method also includes determining whether the user has opened an existing file, created a new file, or closed a file. In one embodiment, the method further includes determining whether the user is actively working on a particular file that is associated with a particular client or matter, so that the time can be accurately attributed to the associated client or matter.

In one embodiment, the method further includes tracking the user's activity to determine whether the user is actively working on an application or an active session (e.g., web based session), wherein the time tracking is associated with the currently active application or session that the user is presently working on during a logged period of time.

These and other embodiments discussed in the Detailed Description of the Preferred Embodiments facilitate the desired transparency of tracking and attributions without requiring continual or redundant, manual user interaction.

### BRIEF DESCRIPTION OF THE DRAWINGS

FIG. 1 is a high-level block diagram of a typical computing environment for implementing various embodiments according to the present invention;

FIG. 2 is a high-level block diagram illustrating an embodiment of the present invention;

FIG. 3 is a flowchart illustrating exemplary steps utilizing the method according to an embodiment of the present invention; and

FIG. 4 is a functional diagram illustrating a more detailed view according to an embodiment of the present invention.

The FIGS. depict embodiments of the present invention for purposes of illustration only. One skilled in the art will readily recognize from the following description that alternative embodiments of the structures and processes illustrated herein may be employed without departing from the principles of the invention described herein.

### DETAILED DESCRIPTION OF THE PREFERRED EMBODIMENTS

There are various solutions for tracking time for users. For example, many attorneys still use paper-based time sheets for tracking their time. Other professionals may use the equivalent in the form of electronic spreadsheets or text documents for manually entering the same information. More sophisticated electronic software solutions also exist for such billing or time tracking purposes (e.g., e-billing software solutions). However, even these more sophisticated solutions typically have the common feature of requiring that the users manually track their time/or take some action to track such time per client.

Accordingly, there exists a need for time tracking and attributions techniques that are not enabled or suggested by the current state of the art. Preferably, a solution meeting this need will improve the transparency of tracking and attributions without requiring continual or manual user interaction.

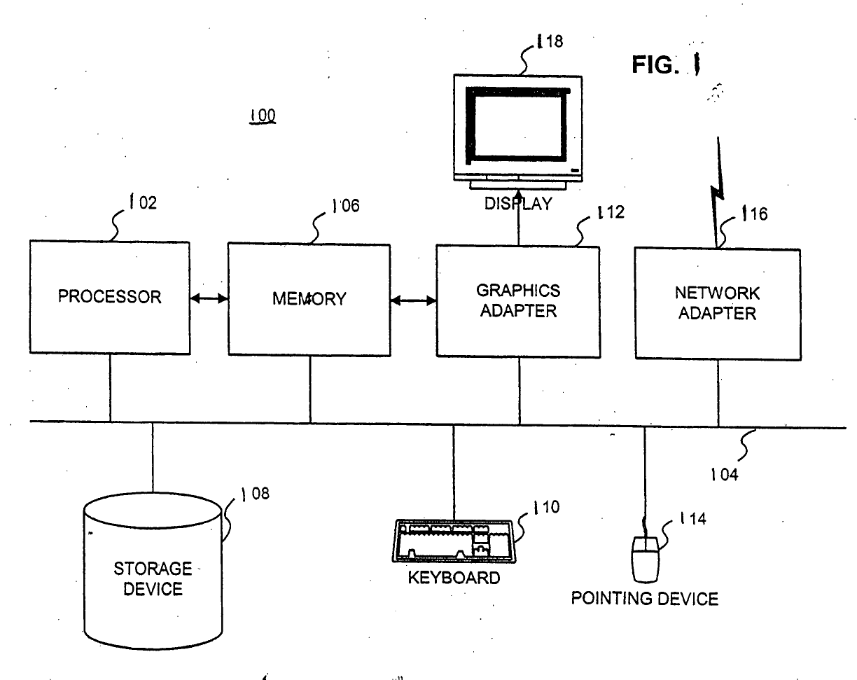

FIG. 1 is a high-level block diagram illustrating a functional view of a typical computer system 100 according to an embodiment of the present invention. Illustrated are at least one processor 102 coupled to a bus 104. Also coupled to the bus 104 are a memory 106, a storage device 108, a keyboard 110, a graphics adapter 112, a pointing device 114, and a network adapter 116. A display 118 is coupled to the graphics adapter 112.

The processor 102 may be any general-purpose processor such as an INTEL x86, SUN MICROSYSTEMS SPARC, or POWERPC compatible-CPU. The storage device 108 is, in one embodiment, a hard disk drive but can also be any other device capable of storing data, such as a writeable compact disk (CD) or DVD, or a solid-state memory device. The memory 106 may be, for example, firmware, read-only memory (ROM), non-volatile random access memory (NVRAM), and/or RAM, and holds instructions and data used by the processor 102. The pointing device 114 may be a mouse, track ball, or other type of pointing device, and is used in combination with the keyboard 110 to input data into the computer system 100. The graphics adapter 112 displays images and other information on the display 118. The network adapter 116 couples the computer system 100 to the network 112.

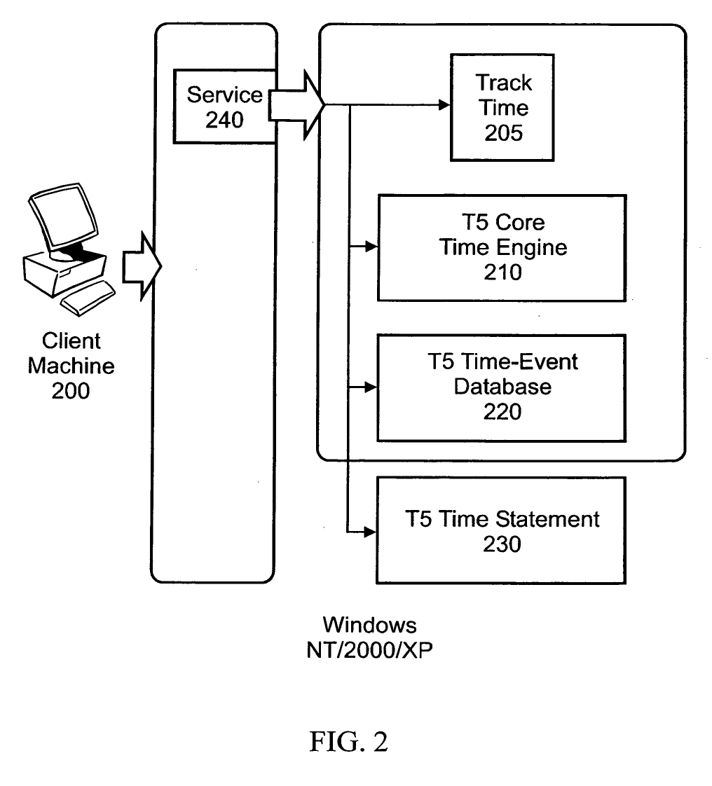

FIG. 2 provides a Client Machine 200 (e.g., a user's computer executing a Microsoft operating system, such as Microsoft Windows 2000/NT/XP™), which is a general purpose computer (such as computer system 100) executing a software embodiment of the present invention to allow the user of the machine to automatically track their activities by time (Track Time 205) in accordance with one embodiment of the present invention. In particular, Client Machine 200 is executing a Core Time Engine 210 that will automatically collect and accurately track time-specific data with respect to a business function entity (e.g., events such as open/create(new)/close file system events, active session related events, other proprietary software product events, such as database activities, etc.). After composing the captured time with respective activity/tasks or any business function entities, Time Statement 230 is generated, which will include important information related to time spent on each activity correlated with business function/cost entities. Time Statement 230 is stored in Time-Event Database 220. For example Time-Event Database 220 can also store any desired attributions associated with such time data, such as user and computer-based activities associated with each time-based event. In one embodiment, Time Statement 230 can be used to also create industry-specific time cards, reports, and/or billing statements.

In particular, in one embodiment Core Time Engine 210, which is implemented as a service, will execute in the background, it will keep tracking the time spent or elapsed time on selected tasks or applications running on user's desktop computer. Core Time Engine 210 will generate Time Statement 230 with all time and event specific information, which will be stored in Time Event Database 220.

In one embodiment, a Core Time Engine 210 is provided, which is implemented as a Service 240 to efficiently track time across various classified entities, such as clients, activities, and skills required for time-billing systems or other customer specific needs. For example, Core Time Engine 210 automatically aggregates stored time based activities and correlates the associated clients and/or projects for purposes of totaling such billable activities across common criteria (e.g., a month of billable activities, and/or based on project billing—accruing such activities to only bill after the billable project is completed) and/or multiple users whose activities may be associated with one or more common clients and/or projects.

In one embodiment, each user has a user profile, which includes information about the user, user's client(s), and each client's project(s) that the user is working on and the applications/software the user is going to use in performing work for that client. For example, in one embodiment, each time the user creates a new file the user is automatically prompted (e.g., a pop-up window with a list of known clients or projects that the user is working on for billable activities with an option to add new clients and new projects) to confirm which client or project should be associated with activities related to that new file. In addition, the preferences can allow the user to allow for the association with a particular client or project to be based on a higher-level file directory (e.g., all new files created in directory /My Documents/Client X/ . . . can be associated with Client X). Similarly, the user can be prompted for such associations when launching new web-based sessions, switching to different websites/domains, launching new applications or database sessions, as well as when the user's activity seems to have not been active in the window/session of focus. The user can also change such associations at any time (while time is being logged for current activities, during configuration/preferences setting, or when reviewing logged activities and correcting/confirming the associations and aggregated time based activities by client and/or project, which can then automatically reconfigure/update such user preferences for future time tracking activities).

In one embodiment, as those skilled in the art will recognize, various types of users with different roles, authorization, and access permission can be identified and user interfaces can be customized based on their need and the product and service plan they choose. In one embodiment, specific Service components can be added to meet various industry specific demands (e.g., Service components can include a security layer to meet specific security requirements of certain customers). In one embodiment, different custom built as well as generic add-in components can be provided to offer different product features, so that customer's can have the option to choose their desired product features and services.

Those skilled in the art will recognize that Core Time Engine 210 can also be implemented as server software or an ASP based software model using agent or agentless based solutions to monitor user activities (Track Time 205) on Client Machine 200. Those skilled in the art will also recognize that Client Machine 200 can be any device on which a user performs activities that can be tracked as billable activities for matters/clients, such as desktop computers, PDAs/handheld devices, phones/cell phones, and other electronic, computing or communication devices.

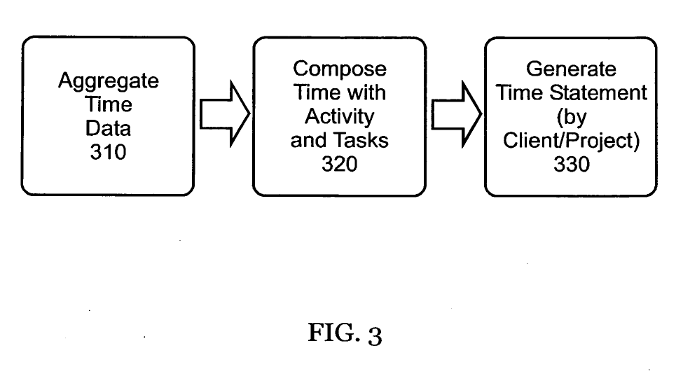

FIG. 3 is a flowchart illustrating exemplary steps utilizing the method according to an embodiment of the present invention. In stage 310, time data is aggregated. In stage 320, time data is composed. In one embodiment, time data is stored in a database (e.g., Time-Event Database 220) for later retrieval. In stage 330, a time report is generated. For example, a time report can be include time and attribution data by client and/or project/matter. Attribution data can include detailed information by computer user activities and specific types of activities. Attribution data can also include the logged details by such user activities (e.g., by document, by session, by application, with logged data associated with each such recorded activities).

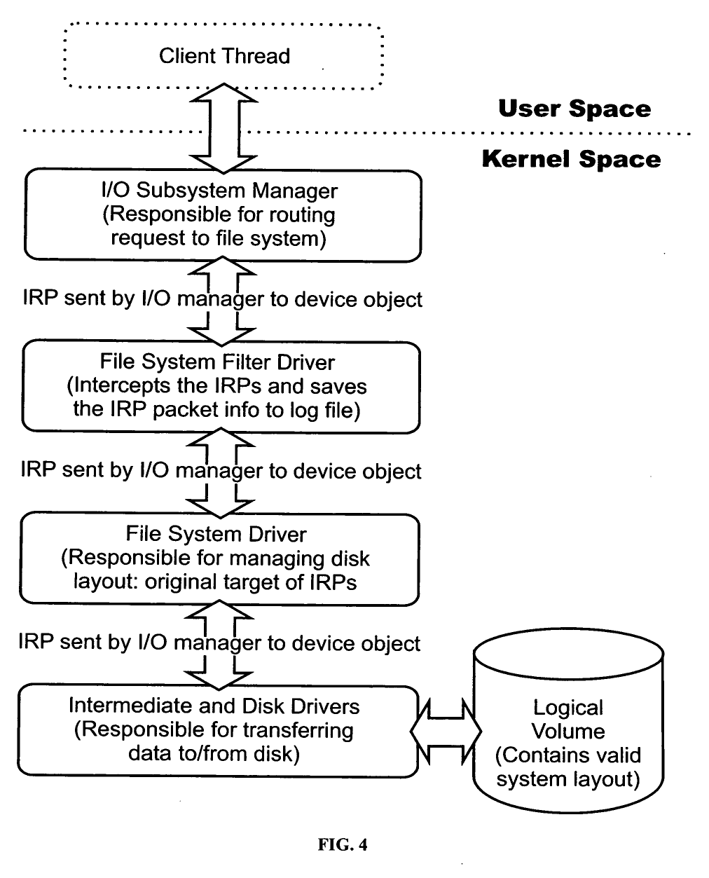

FIG. 4 is a functional diagram illustrating a more detailed view according to an embodiment of the present invention. In one embodiment, the present invention is implemented as software that executes on the Microsoft Windows XP™ operating system/platform. In this embodiment, a file system filter driver is provided to intercept Internal Request Packets called IRPs (Internal Request Packet, which represents the smallest data unit used by Windows I/O manager to communicate across Windows File system driver and I/O Manager) going to/from file system's I/O manager and File System driver in the kernel space of the operating system, creating a log of all IRP packet information. The IRP contains information about file activity including file create/open, close, read and write, file name, access time, application time, and user name. This log file is then parsed by a set of simple parsers to extract the meaningful data required by the Time Tracking Engine 210. The parsed data is then placed in a data store, such as Time-Event Database 220 (e.g., a flat/structured file or a relational database), prior to being displayed for users or retrieved for automatically generating activity logs, time sheets, or bills.

In accordance with one embodiment, the active file is recognized by where the cursor is located, in other words where keystrokes can be or are being entered. When multiple files are open in an application or applications, one file always has focus, or in other words, the cursor is located in that file window. For example, determining the active file/application/session is described further below.

The following definitions are provided for reference purposes only, as those of ordinary skill in the art will recognize these terms (e.g., see Microsoft Developer Network materials—MSDN).

File System Filter Driver:

A File System Filter Driver is a special type of layered driver, which is invisible. It attaches itself to file system driver and intercept requests directed at a lower driver's Device objects. It is developed primarily to allow the addition of new functionality beyond what is currently available. The file system filter driver may either use the services of the original target of the I/O request, or use the services of other kernel-mode drivers to provide value-added functionality. Filter Drivers are used to add features to a device without modifying the underlying device driver or the programs that use the device. Filters allow applications, such as software embodiments of the present invention, to modify some aspects of an existing driver's behavior without re-writing the underlying driver.

File System Driver:

A file system driver is a component of the storage management subsystem. It provides the means for users to store information and retrieve it from nonvolatile media such as disks or tapes. File System Drivers are tightly integrated with an Operating System's Memory Manager and Cache Manager subsystems.

Below is a description of the File System Filter Driver Model in accordance with one embodiment of the present invention on the Microsoft Windows XP™ operating system.

File System Filter Driver Model

The file system driver receives requests to open, create, read, write and close files on disks. These requests typically originate in the user process and are dispatched to the file system via the I/O subsystem manager. FIG. 4 describes how a local file system driver provides services to a user/client thread in accordance with one embodiment of the present invention.

In particular, referencing FIG. 4, a user/client thread, at stage 410, issues an I/O function call, the Operating System (e.g. Win32) subsystem invokes the corresponding service call to request the operation on behalf of the caller. At this point the CPU switches to kernel-mode privilege level. The I/O Subsystem Manager (responsible for routing request to file system) 415 builds an I/O Request Packet (IRP), at stage 420, describing the I/O request and calls the File System Driver (intercepts the IRPs and saves the IRP packet info to a log file) 425 at the appropriate dispatch entry point and the IRP is intercepted by the filter driver, at stage 430. The File System Driver, at stage 435, performs appropriate processing and returns the results to the I/O Manager at stage 440, which in turn returns them to the Operating System (e.g. Win32) subsystem (the privilege level switches back to user-mode), and the Operating system (e.g. Win32) subsystem eventually returns the results to the requesting process (stage 445)—intermediate and disk drivers (responsible for transferring data to/from disk, such as logical volume 450).

In one embodiment, the IRP information about the IRP sequence number, process ID, thread ID, application name, file name, device object, user name, file operation activities (IRP major and minor operation codes) along with its completion time are utilized to log events for time tracking attributes. In particular, with this co-related information about the IRP packets and information from the user's profile, the elapsed time is derived for user activities co-related to multiple dimensions like user, session (process id, thread id), client, project, application, file, status of the file, and activity on the file.

In one embodiment, the IRP Active hook is used to track a particular Session ID to monitor whether a user is actively using a particular session, such as a web-based session. This can be monitored along with IP address information and/or URL information to log the user's activities in a particular web-based session. For example, this technique can be used to monitor an attorney's research time on a Lexis-Nexis research session for a particular client matter to accurately bill that attorney's time and legal research time to that client. Alternatively, a special hook or interface with Lexis-Nexis can be used to automatically receive/request the Lexis-Nexis logged time/search costs associated with the user's entered client/project code during that Lexis-Nexis session or a set of sessions (e.g., during the past month for that user's Lexis-Nexis account).

In one embodiment, the IRP Active hook is used to track which file, application or web-based session is actually active (e.g., the window on the user's computer or workstation that is the current focus of the user's activities). This allows, for example, an accurate discrimination of logged time/activities when the user has multiple files, applications, and/or web-based sessions (which may or may not be associated with the same client/project) open at any given time to avoid double-billing (over allocation of time for a client or project as the user typically can only be doing billable activities for one client/project at any given time). This embodiment can also allow for determining if the user is actively working on the currently active session (e.g., this can be configured based on the user's preferences to allow for a time-out based on inactivity, such as based on keystroke, read/write activities in the active session or that the screen-saver begins to execute, after a pre-configured period of time, e.g., 5 minutes).

In one embodiment, if there is no activity detected on an open file or active session for a particular amount of time, which can be a preconfigured period of logged time, then the user will be asked through a popup window if the user is still working on that activity and whether the time should continue to be logged/billed. If the user indicates that they are not still working on that activity (or if the user fails to respond within a preconfigured period of logged time), then the logged time is stopped. Otherwise (the user indicated that they are still working that activity), the time for that activity will continue to be billed/logged (and the preconfigured period of logged time tracker is reset).

Those of ordinary skill in the art will recognize that such logged activities can be used to automatically generate bills, in printed invoice formats and/or electronic bills to send to clients/customers.

Although this embodiment is an example of an implementation on the Microsoft Windows XP™ operating system, those of ordinary skill in the art will recognize how to also implement the present invention on other platforms and Operating Systems (OS), such as the Apple/MAC OS, Linux and Unix based OSs, for other computing platforms, as well as OSs for handheld and cellular devices, such as Palm OS, Microsoft CE/Pocket PC OSs, Real-time embedded OSs, and SYMBIAN OS. Those of ordinary skill in the art will also recognize that disclosed software embodiments can be implemented in any of the current programming languages: C, C++, Perl, Visual Basic, C#, Java, and others.

The preferred embodiments can be used in a variety of time tracking and attributions related applications. Such applications include, without limitation, the following:
Timing and attribution of work in a computing or communication device
Timing and attribution of telephone calls in a VOIP (Voice Over IP telephony) system (and other telephone calls manually, e.g., a cellular device)
Timing and attribution of work product in a PDA
Categorizing of work time product by job, project, client, or any other classification
Tracking and attributing work of virtual employees
Tracking and attributing work of students; local and online—instructors can compare grades to time spent on lessons to discover which students need encouragement and extra attention
Tracking and attributing of call-center work or customer service work
Tracking and attributing the workforce management work that will help to budget, schedule, estimate and cost of the work/effort time and manage the time shifts, transportation/commute of crew/work force to serve the customers on time, on budget effectively.
Aggregation and reporting of timed and attributed work product records of many employees, contractors, or students
Reporting of timed and attributed work product in various and customizable forms to spreadsheet and financial software as well as in other forms such as CSV and text
Reporting of timed and attributed work product as tables, invoices, statements, memos, web pages (e.g., an attorney working in a LEXIS web-based research session), email messages, database files or raw data
Automatic reporting of timed and attributed work product by email, printed mail, or http transfer, to supervisors, clients, project managers, teachers
Providing methods to classify timed and attributed work product by job, client, project, or any other classification
Creation of a database of tasks and time needed to complete them
Tracking of elapsed time of tasks for time-to-completion reports
Comparison of task times between employees for efficiency

Those skilled in the art will recognize that there are other applications that would benefit from the disclosed preferred embodiments. For example, the present invention can be implemented as a software package and implemented to provide the framework for building customized productivity applications, time tracking and management solutions, add-ins for other industry specific needs to co-relate time with various business functions/activities in specific market segments, such as inventory, transportation (cargo/freight), health care, government contracts, professional services, etc.

Accordingly, the present invention provides improved systems and methods for time management and attributions. The above detailed description is included to illustrate the operation of the preferred embodiments and is not meant to limit the scope of the invention. The scope of the invention is to be limited only by the following claims. From the above discussion, many variations will be apparent to one skilled in the relevant art that would yet be encompassed by the spirit and scope of the invention.

1. A method for tracking a user's activity by time, the method comprising:
monitoring the user's activity on a computer; and
automatically tracking a plurality of user activities by time, wherein each of the plurality of user activities is automatically associated with a billable activity.

2. The method of claim 1, wherein the monitoring further comprises:
determining whether the user has opened an existing file, created a new file, or closed a file.

3. The method of claim 2, wherein the monitoring further comprises:
determining whether the user is actively working on a first file.

4. The method of claim 3, wherein the monitoring further comprises:
determining whether the user is actively working on a second file, wherein the first file and the second file are both currently open files.

5. The method of claim 1, wherein the monitoring further comprises:
aggregating and correlating logged user activities with a plurality of projects, and wherein the user is automatically prompted to associate a particular new activity with a project through a popup window.

6. The method of claim 5, wherein the monitoring further comprises:
associating the plurality of projects with a client for purposes of automatically generating periodic bills.

7. The method of claim 1, wherein the monitoring further comprises:
tracking multiple file operations to identify file opens, creates and closes in order to associate the user's activity with particular files being worked on by that user on behalf of one or more clients.

8. The method of claim 1, wherein the monitoring further comprises:
tracking multiple applications in order to associate the user's activity with particular files or sessions being actively worked on by that user on behalf of one or more clients,
whereby a billable activity summary can be automatically generated for the user for a plurality of clients.

9. The method of claim 1, wherein monitoring further comprises:
tracking the user's activity to determine whether the user is actively working on one or more active sessions, wherein the time tracking is associated with the currently active session that the user is presently working on during a logged period of time, and wherein the active sessions comprise a web-based session or an office productivity based session.

10. An apparatus for tracking a user's activity by time, the apparatus comprising:
means for monitoring the user's activity on a computer;
means for automatically tracking a plurality of user activities by time; and
means for aggregating and correlating the activity by time with a plurality of projects, and wherein the user is automatically prompted to associate a particular new activity with a project through a popup window.

11. The apparatus of claim 10, wherein the means for monitoring further comprises:
means for determining whether the user has opened an existing file, created a new file, or closed a file.

12. The apparatus of claim 11, wherein the means for monitoring further comprises:
means for determining whether the user is actively working on a first file.

13. The apparatus of claim 12, wherein the means for monitoring further comprises:
means for determining whether the user is actively working on a second file, wherein the first file and the second file are both currently open files.

14. The apparatus of claim 10, wherein the means for monitoring further comprises:
means for automatically allocating the activity by time with a plurality of projects based on preconfigured user preferences.

15. The apparatus of claim 14, wherein the means for monitoring further comprises:
means for associating the plurality of projects with a client for purposes of automatically generating periodic bills.

16. The apparatus of claim 10, wherein the means for monitoring further comprises:
means for tracking multiple file operations to identify file opens, creates and closes in order to associate the user's activity with particular files being worked on by that user on behalf of one or more clients.

17. The apparatus of claim 10, wherein the means for monitoring further comprises:
means for tracking multiple applications in order to associate the user's activity with particular files or sessions being actively worked on by that user on behalf of one or more clients,
whereby a billable activity summary can be automatically generated for the user for a plurality of clients.

18. The apparatus of claim 10, wherein means for monitoring further comprises:
means for tracking the user's activity to determine whether the user is actively working on one or more active sessions, wherein the time tracking is associated with the currently active session that the user is presently working on during a logged period of time, and wherein the active sessions comprise a web-based session or an office productivity based session.

19. An apparatus for tracking a user's activity by time for a computing or communication device on which the user performs activity that needs to be monitored for time activities for client or project billing purposes, the apparatus comprising:
a device for performing user activity; and
the device comprising executable software for automatically tracking a plurality of user activities by time; for determining whether the user has opened an existing file, created a new file, or closed a file; for determining an active file; for logging activities while the active file is being worked on by the user; and for automatically allocating logged activities by time with a plurality of projects for generation of electronic bills.

20. A storage medium comprising executable instructions for tracking a user's activity by time for a computing or communication device on which the user performs activity that needs to be monitored for time activities for client or project billing purposes, the storage medium comprising:
executable instructions to automatically track a plurality of user activities by time for determining whether the user has opened an existing file, created a new file, or closed a file; and for logging activities for an active file while it is being worked on by the user; and
executable instructions for allocating the logged activities by time with a plurality of projects for generation of electronic bills.
